(19) United States
(12) Patent Application Publication
(10) Pub. No.: US 2009/0143877 A1
(43) Pub. Date: Jun. 4, 2009

(54) METHOD OF CONTROLLING A PORTABLE USER DEVICE

(75) Inventor: Krishna Prasad Panje, Bangalore (IN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,652

(22) PCT Filed: Dec. 9, 2004
(86) PCT No.: PCT/IB04/52722

§ 371 Date: Jun. 20, 2006

(30) Foreign Application Priority Data
Dec. 23, 2003 (EP) 03104944.8

(51) Int. Cl. G05B 15/00; G06F 1/16

(52) U.S. Cl. 700/83; 700/302

(57) ABSTRACT

The invention relates to a method of controlling a portable user device (100, 420), the method comprising the steps of (260) detecting a change of orientation of the portable user device, and (270) selecting, upon said detection of the orientation change, at least one command from a list of commands. The device may automatically personalize its user interface and provide, for instance, different functionalities to respective users.

The invention relates to a portable user device and to a method of controlling the portable user device.

Document WO03/077087 discloses a portable electronic device comprising position sensors to determine a spatial position of the device. By detecting a predetermined orientation of the device, a respective switch is made to an associated mode of operation of the device. A mobile phone mode is activated when the device is in the upright position, and a PDA mode is activated in the horizontal position.

The detection of the position of the known device allows its control in a restrictive manner. The mode of operation of the device is rigidly fixed with the particular spatial arrangement.

It is an object of the invention to provide a portable device which can be controlled in a more flexible manner.

The object is realized in that the method of the present invention comprises the steps of:
detecting a change of orientation of the portable user device,
selecting, upon said detection of the orientation change, at least one command from a list of commands.

The orientation of the device may be changed in any manner, and said change will trigger the device to select one command or many commands from the list. Thus, the device will select at least a command not only when the device is in a particular position but also when any change of orientation occurs. In said aspect, the device may be controlled in a more flexible manner than in WO03/077087.

The device may be arranged to select at least one command from the list of commands. The list of commands may be ordered, and the device may sequentially select commands from the list every time in response to the change of orientation. The commands are selected in a sequence of their order in the list, one by one, or several commands may be selected upon every detection of the orientation.

It is possible to re-arrange the list of commands. For example, the order of the commands may be changed. In another example, commands may be added to or deleted from the list.

In one of the examples, the portable device may advantageously be used by a plurality of users, while each user awaits his turn to use the device. When it is the user's turn to use the device, the device may automatically personalize, for instance, a user interface of the device. The device may provide different functionalities to respective users.

The object of the invention is also realized in that the portable user device according to the invention comprises:
a detector for detecting a change of orientation of the portable user device, and
control means for selecting at least one command from a list of commands upon said detection of the orientation change.

The device may operate as described in accordance with the method of the present invention.

These and other aspects of the invention will be further explained and described with reference to the following drawings:

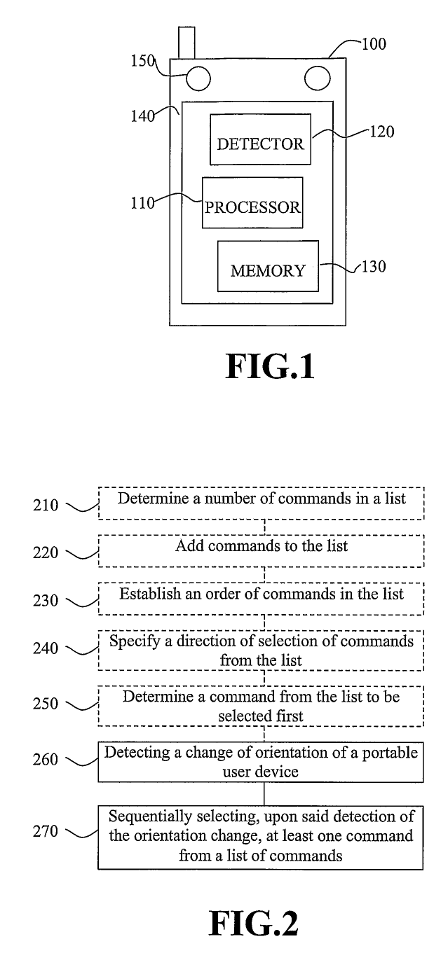

FIG. 1 is a functional block diagram of an embodiment of a portable device according to the present invention;

FIG. 2 is an embodiment of the method of the present invention.

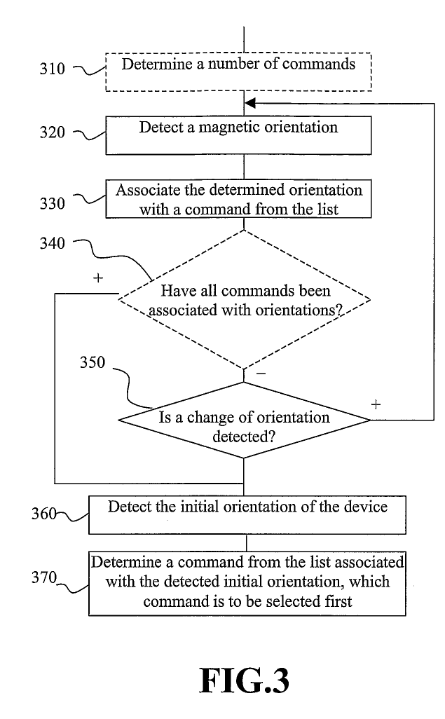

FIG. 3 is an embodiment of the method of the present invention, wherein an example of selection of a first command from a list is shown, and

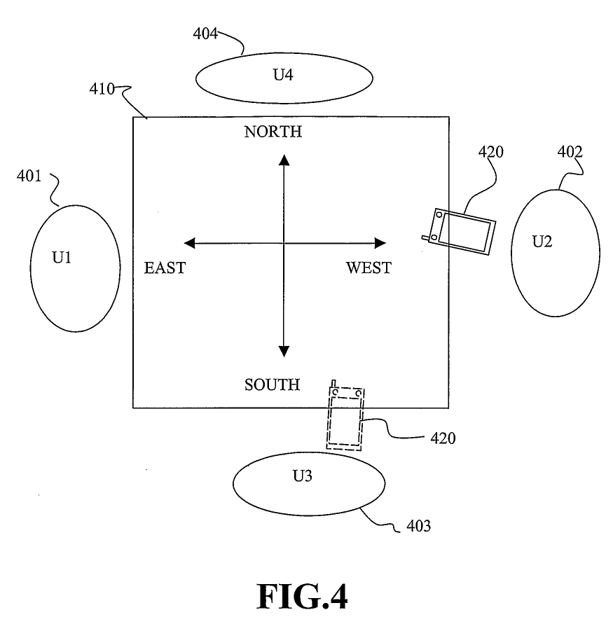

FIG. 4 is an embodiment of the present invention, wherein a plurality of players using a portable device for playing a game is shown.

FIG. 1 shows a portable user device 100 according to the present invention, which device is preferably sufficiently small-sized and light-weight so as to be held by a user in one hand and to be oriented in different spatial positions.

The portable device 100 may comprise a data processor 110 (generally, control circuitry) and a detector/sensor 120. The processor may be a well-known central processing unit (CPU) suitably arranged to implement the present invention and allow operation of the device as explained herein.

The detector 120 may be arranged to detect a change of orientation (e.g. within a range) of the portable user device. For example, the detector may comprise a sensor for sensing the spatial orientation of the device. The detector may be arranged to regularly interrogate the sensor on the current orientation of the device, or once in a predetermined time period. A sensor of this type is known per se. For example, acceleration sensors, (laser) gyroscope sensors, ultrasonic detection sensors, etc. may be used. It should be noted that the detector does not necessarily determine the orientation of the device, and a mere detection of the change of orientation by some means may suffice. Such an orientation change detector may actually be cheaper than the orientation sensor.

Low-cost orientation sensors are known as such. For instance, a microcontroller for detecting the change of orientation may be provided with two orthogonally mounted tilt meters for measuring X and Y-tilts of the device with respect to gravity. The meter may be mounted on a printed circuit board, and include a silicon wafer whose surface is micromachined to produce a capacitor deflectable by gravity to vary its capacitance in response to a gravity change. However, the sensor is preferably arranged to sense a change of magnetic orientation as a well-known electronic compass, with respect to the north, south, west and east references. Such a sensor may correctly detect the change of orientation, for example, when the device is passed from one user to another user.

To increase reliability of the detection, the detector may be arranged to weigh the change of orientation with regard to a period of time within which the change occurred. If the device is passed from one user to another, the period of the orientation change may be longer than when the device is rotated by the user by chance. Also, an amplitude value of the orientation change may be taken into account. A threshold value for the orientation change may be employed. The threshold may be, for instance, a yaw angle of a turn of the device versus a speed of the turn.

The detector may also be arranged to detect changes of orientation in three dimensions. It will be appreciated that the laser gyroscope can advantageously generate either 2D or 3D position data.

The device 100 may additionally comprise a memory unit 130, for example, a known RAM (random access memory) memory module. The processor 110 may be arranged to read from the memory at least one command of the list of commands stored in the memory. Furthermore, the processor 110 may sequentially select at least one command read from the list stored in the memory 130 upon detection of the change of orientation by said detector 120.

Further details of the construction of the portable device may vary depending on the type of command selected by the processor. For example, if the command enables a corresponding user interface of the device, the device may comprise a display 140 and/or audio reproduction unit, e.g. speakers 150. In further examples, the memory may store a command for playback of media content stored in the memory, or a command for selecting a particular genre of media content. The device may comprise a speaker for reproduction of audio signals received from a particular content provider by virtue of the selection of a corresponding command.

In fact, the invention is not limited to the detection of the change of orientation of the device, but the detector 120 may alternatively be arranged to detect the change of orientation of a part of the device, e.g. the orientation of a rotating switch on the device or the orientation of an antenna of a radio receiver built in the device.

FIG. 2 shows an embodiment of the method of the present invention.

The list of commands may be created by means of the portable device, or the list may be downloaded to the portable device from another source. Steps 210, 220 and 230 of the method are optional. In step 210, a number (amount) of commands to be included in the list is determined. In step 220, the commands are defined and added to the list. In step 230, an order of commands is established in the list, e.g. the commands may be sorted according to some value, rule, rating, etc. Steps 210 to 230 may be performed in various manners, using the portable device incorporating user input means such as, for instance, a keyboard, touch screen, pen-pointing device, voice recognition, or remote control.

The method may also optionally comprise step 240 of specifying a direction of selection of commands from the list, e.g. upward from the bottom to the top of the list, or downward from the top to the bottom of the list, or from the middle to the bottom of the list, etc. Optionally, in step 250, a first command, i.e. a command from the list to be selected first, may be selected.

Furthermore, the method comprises the step 260 of detecting the change of orientation of the portable user device; and the step 270 of sequentially selecting, upon said detection of the orientation change, at least one command from a list of commands. For example, upon detection of the change of orientation, the device selects one command, which may immediately be executed by the processor of the device; and, upon detection of another change of orientation, the device may select the next command from the list which follows the previously selected command in the upward (downward) direction, or in an ascending (descending) order of the commands.

After the list of commands is available in the portable device, the device may be arranged to select, for example, the command from the list to be selected first in a random manner, take the first command at the top of the list, and select the first command depending on an orientation of the device. FIG. 3 shows an embodiment of the method of the present invention, wherein an example of the selection of the first command based on the initial orientation of the device is shown.

In step 310, the number of commands to be included in the list is established. In step 320, the current magnetic orientation of the portable device is detected. It may also be verified whether the detected current orientation is different from the orientations which had already been detected.

In step 330, the detected orientation may be associated with a command, and the command may be defined or generated at the same time. Of course, the commands might be predetermined as well. For example, the commands may enable a radio receiver embedded in the portable device to tune to a particular radio station. In step 330, the list of such commands and corresponding commands may be associated with respective orientations of the portable device. In step 340, it is checked whether all commands have been associated with orientations. If the result is negative and there are no associated commands, steps 320 and 330 are repeated, when the next change of orientation is detected in step 350. If all commands have received their associated orientations, the “set-up” sequence of steps is finished. In step 360, the initial orientation of the portable device is detected, and based on this, the first command to be selected from the list may be determined in step 370. The first command is the command associated with the detected initial orientation, as determined in step 370. After the first command has been found, the commands subsequent in the list are to be selected upon further changes of orientation of the device. The embodiment shown in FIG. 3 has the advantage that any command may be the first command, depending only on the initial orientation of the device.

In a further embodiment, the portable device according to the invention may be used by a plurality of users on a turn-by-turn basis. For example, people sitting around a table are in a meeting, and questions to be answered by people are posed. If there is no white board or other way to make the questions visible to people, the questions may be written down on the portable device. Each person would like to answer the questions but does not want others to see his comments. Thus, the persons pass the portable device on which they write their comments on one question to each other. At each turn, the person comments on one question. To enable said scenario, the portable device may comprise a list of persons who use the device to write down their comments. For each person, a corresponding command may be included into the list for generating a personal file with comments stored in the memory of the device, for instance. When it is the person's turn to input his comments to the device, the corresponding command is selected. Basically, the command may be a command for personalizing a User Interface of the device for a particular user. Whenever the device is passed from one person to another, the detector of the device detects the change of orientation, and sequentially selects the command from the list in response to the detection of the orientation change. In the described manner, the device may ensure that each person has the opportunity to provide his input and that the person will not miss his turn (for example, the name of a person, whose turn has come, may be displayed).

In a further embodiment, the portable device may enable the user to modify the command or commands selected when it is the user's turn to use the portable device. The device may also allow the user to add or delete the commands which the device selects for him.

It is an advantage of the present invention that the number of commands in the list does not depend on the orientations of the persons but on whether the change of orientations is detected. Thus, the number of commands may be independent of the number of persons and their respective orientations.

FIG. 4 illustrates another embodiment of the present invention. FIG. 4 shows persons 401 (U1), 402 (U2), 403 (U3) and 404 (U4) sitting around a table 410 and playing a game. The players should not reveal their cards to each other, except when there are game partners between them. When the game is to be started, the player 402 picks up a portable computer, e.g. a PDA (personal digital assistant) 420 to play his turn, for example. The PDA generates a game session for the player 402. The PDA displays only cards of the player 402. The cards of other players are hidden from the player 402. The PDA enables the player 402 to provide his input, and when the player 402 is ready (he may press a button “finish”), the display of the PDA is switched off, for instance. The player 402 passes the PDA to the player 403. The PDA detects the change of orientation of approximately 90 degrees. The player 403 takes the PDA and presses a button “start”, and the PDA may generate and display a game session for the player 403. The PDA may also make a brief sound to notify other users that the player 402 has finished his turn, and now the PDA displays a game session for the next player 403. This may be particularly advantageous to ensure that players correctly follow the rules of the game. The players may further pass on the PDA in a clockwise order and continue using the PDA as described above for subsequent rounds (loops). The PDA will recognize that the next user interface should be displayed because the change of orientation of a certain degree has occurred. The extent of the orientation change may be stored in the PDA after the first round (loop U1-U2-U3-U4) of the game is finished.

It should be noted that the determination of the orientation of users is not required in the example shown in FIG. 4. The PDA selects the displays based on the order of the game, i.e. the commands in the list. However, the PDA may also determine the orientation of each user or the location of the user, e.g. the place of the player around the table. When the player changes his orientation or place, his new orientation or place may be detected and stored. That has the advantage that the game does not have to be followed in the same order/direction of each loop.

In another embodiment of the invention, more than one device may be used by a number of users on the turn-by-turn basis. The users may pass two devices between their mates. The devices may have wireless communication means and synchronize their lists of commands, order of selection, etc.

The portable device according to the present invention may be arranged to function as an audio/video player which selects commands for playback of media content or a particular genre of media content to be presented, which is responsive to the change of orientation. For example, the PDA may store different folders with music content of a certain genre. The folders may be associated with the magnetic orientations of the device. A function “playback” of the device may also be attached to some change of orientation, e.g. a very radical change of orientation (of a large magnitude) of the device.

In another example, the PDA may be equipped with a remote control unit for controlling consumer electronics devices placed in, for example, the north, north-east and north-west directions. When the PDA is oriented towards the north, the PDA will display settings of the consumer device placed in the north direction, etc. For example, the PDA may also switch between control functionalities for different controllable consumer devices on the basis of their orientation.

The present invention provides a very easy and user-friendly manner of controlling the portable device.

Various computer program products may implement the functions of the device and method of the present invention and may be combined in several ways with the hardware or located in different other devices.

Variations and modifications of the described embodiment are possible within the scope of the inventive concept. For example, the device according to the present invention may be incorporated into a portable TV receiver, a mobile phone or a game console. In one example, the device may be arranged to identify a person by his voice, e.g. by analyzing the speech of the person and comparing results of the analysis with his audio profile data, in any known manner. Thus, the identity of the person may be established, and it may be used, for example, for determining a first player in the game.

The use of the verb ‘to comprise’ and its conjugations does not exclude the presence of elements or steps other than those defined in a claim. The invention can be implemented by means of hardware comprising several distinct elements, and by means of a suitably programmed computer. In the system claim enumerating several means, several of these means can be embodied by one and the same item of hardware.

1. A method of controlling a portable user device (100), the method comprising the steps of:
(260) detecting a change of orientation of the portable user device, and
(270) selecting, upon said detection of the orientation change, at least one command from a list of commands.

2. The method of claim 1, further comprising a step (210) of determining a number of commands in the list, and/or a step (230) of determining an order of the commands in the list.

3. The method of claim 1, further comprising a step (250) of determining a first command, the first command being one of the commands to be selected first.

4. The method of claim 3, further comprising a step (330) of associating the command with a particular orientation of the device, and a step (370) of recognizing the particular orientation of the device and the associated command.

5. The method of claim 3, wherein a change of location of the portable user device is additionally detected for enabling said selection of the first command.

6. The method of claim 1, further comprising a step (240) of determining a direction of the selection from the list.

7. The method as claimed in claim 1, wherein the predefined command comprises at least one of:
a command for enabling a corresponding user interface of the portable user device;
a command for playback of media content;
a command for selecting a particular genre of media content;
a command for receiving signals from a particular content provider; and
a command for selecting a particular signal to be transmitted.

8. A portable user device (100) comprising:
a detector (120) for detecting a change of orientation of the portable user device, and
control means (110) for selecting at least one command from a list of commands, upon said detection of the orientation change.

9. The device of claim 8, comprising at least one of a portable computer, a remote control, a portable radio receiver, a portable TV receiver, a PDA, a mobile phone, or a game console.

10. (canceled)
